(19) United States
(12) Patent Application Publication
(10) Pub. No.: US 2026/0221011 A1
(43) Pub. Date: Jul. 30, 2026

(54) CONTROLLER GENERATED FEEDBACK SIGNAL TO MODIFY HAPTICS DRIVE SIGNAL

(71) Applicant: TEXAS INSTRUMENTS INCORPORATED, Dallas, TX (US)

(72) Inventors: Supriyo PALIT, Richardson, TX (US); Jasjot Singh CHADHA, Allen, TX (US); James Kelly GRIFFIN, San Diego, CA (US)

(21) Appl. No.: 19/041,760

(22) Filed: Jan. 30, 2025

(51) Int. Cl. G08B 6/00; G06F 3/01

(52) U.S. Cl. CPC G08B 6/00; G06F 3/016

(57) ABSTRACT

A system and associated processes include an amplifier to amplify a drive signal and a haptics actuator having an input coupled to an output of the amplifier. The haptics actuator vibrates responsive to the drive signal. The system further includes a voltage sensor coupled to the input of the haptics actuator to measure a voltage measurement of the drive signal and a current sensor coupled to the input of the haptics actuator to measure a current measurement of the haptics actuator in response to the drive signal. A controller is coupled to an output of the current sensor and an output of the voltage sensor. The controller receives the voltage and current measurements and generates a feedback signal responsive to the voltage and current measurements and modifies the drive signal responsive to the feedback signal.

### BACKGROUND

Haptic actuators are devices that provide tactile feedback by generating vibrations or forces. They are commonly used in smartphones, gaming controllers, and wearable devices to enhance user interaction by simulating touch sensations. By varying the intensity, frequency, and pattern of the vibrations, haptic actuators can create realistic feedback for notifications, virtual buttons, and immersive experiences in gaming or virtual reality.

### SUMMARY

In at least one example, an apparatus includes a memory storing an adaptive model and an algorithm executable to generate a drive signal of a haptic actuator. A processor is configured to access the memory and execute the algorithm to modify the adaptive model responsive to one or both of a voltage measurement of the drive signal and a current measurement of the haptics actuator responsive to the drive signal, and to generate a feedback signal responsive to the adaptive model, where the drive signal is responsive to the feedback signal.

In at least one additional example, a system includes an amplifier to amplify a drive signal and a haptics actuator having an input coupled to an output of the amplifier, wherein the haptics actuator vibrates responsive to the drive signal. The system further includes a voltage sensor coupled to the input of the haptics actuator to measure a voltage measurement of the drive signal and a current sensor coupled to the input of the haptics actuator to measure a current measurement of the haptics actuator in response to the drive signal. A controller is coupled to an output of the current sensor and an output of the voltage sensor. The controller receives the voltage and current measurements and generates a feedback signal responsive to the voltage and current measurements and modifies the drive signal responsive to the feedback signal.

In at least one additional example, a computer program product for generating a drive signal configured to cause a haptics actuator to vibrate, the computer program product including a computer-readable storage medium having computer-readable program code embodied therewith, the computer-readable program code to be executed by a controller to modify an adaptive model of a haptics actuator responsive to a voltage measurement of a drive signal and a current measurement of the haptics actuator in response to the drive signal, and to predict a back electromagnetic force of the haptics actuator responsive to the adaptive model, and to generate a feedback signal responsive to the prediction.

### BRIEF DESCRIPTION OF THE DRAWINGS

FIG. 1 is a block diagram of an illustrative system that generates a drive signal used to cause a haptics actuator to vibrate responsive to an output from an adaptive model in various examples.

FIG. 2 is a block diagram of an example of a system including a controller to cause a haptics actuator to vibrate in a manner responsive to an output from an adaptive model with various examples.

FIG. 3 is a block diagram of an example of another system including a controller to generate a drive signal to control the vibrations of a haptics actuator in various examples.

FIG. 4 is a block diagram of an example of another system that includes an adaptive model trained on voltage and current measurements and that is included within a controller that causes a haptics actuator to vibrate responsive to waveform characteristics of a drive signal in various examples.

FIG. 5 is a flowchart of an example of a method of controlling vibrations at a haptics actuator responsive to a haptics waveform signal that is modified by an adaptive model in various examples.

FIG. 6 is a flowchart of an example of a method of modifying an adaptive model to adjust a drive signal to control the vibrations of a haptics actuator in various examples.

FIG. 7 is a block diagram of an example of a system that includes a controller that is coupled to a haptics actuator in various examples.

### DETAILED DESCRIPTION

Haptic actuators use transducers having relatively long and narrow bandwidths, along with long spatial pulse lengths and low damping. While these properties promote strong vibrational strength, the resonance frequencies inherent to such transducers exhibit prolonged ringing during haptics braking. This ringing presents challenges to achieving a crisp, haptics braking effect. Such challenges are exacerbated in high latency environments where long transmission times preclude responsive waveform adjustment.

Examples described herein reduce prior limitations by modulating a haptics drive voltage using model-based electromotive force (EMF) tracking. More particularly, an adaptive model receives feedback in a loop without latency otherwise attributable to EMF measurement transmission times. The adaptive model is continuously or periodically updated per the braking characteristics of the haptics actuator. In this manner, the system achieves responsive tracking and braking without suffering instability from latency.

For example, the adaptive model outputs current and voltage measurements to tune the drive signal. The drive signal is thus generated before the measurement transmissions can arrive at a waveform generator. A feedback signal is output without latency by virtue of the adaptive model being included within the controller. As such, implementations present a hybrid approach that allows instantaneous, modeled updates to the drive signal, while the adaptive model is updated responsive to real time voltage and current measurements. Implementations position the adaptive model within a controller to leverage the existing processing and memory resources.

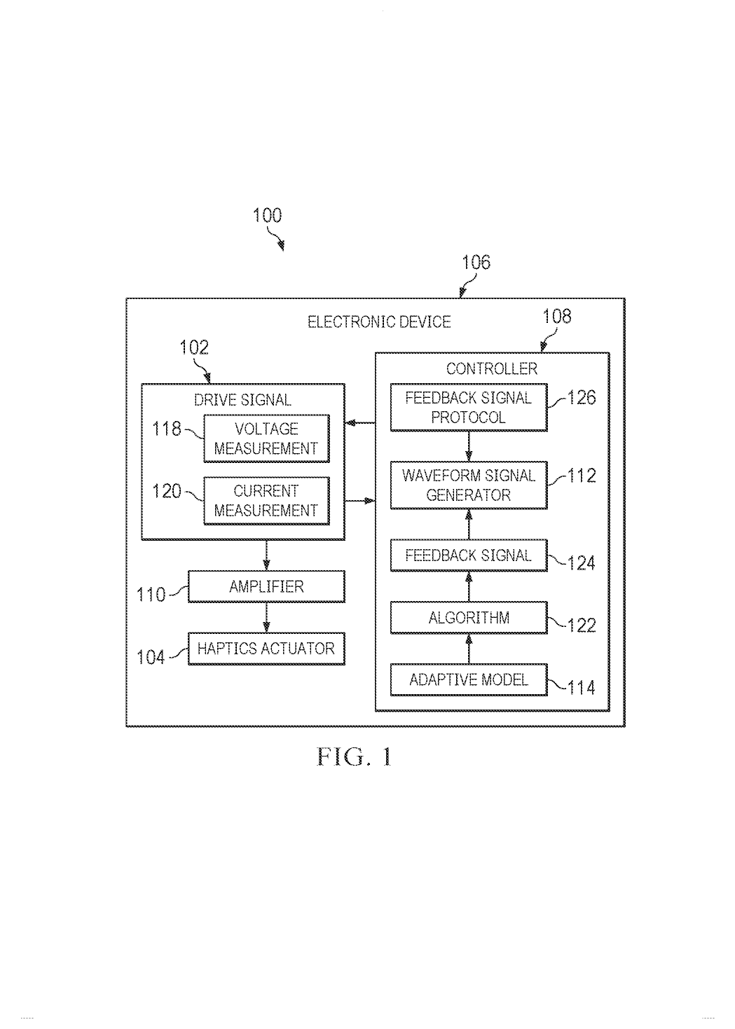

FIG. 1 is a block diagram of an illustrative system 100 that generates a drive signal 102 used to cause a haptics actuator 104 to vibrate responsive to an output from an adaptive model 114. The haptics actuator 104 of FIG. 1 is included as part of an electronic device 106 of the system 100. As shown, the electronic device 106 also includes a controller 108 and an amplifier 110.

The controller 108 includes a waveform signal generator 112. The waveform signal generator 112 outputs a waveform having an embedded haptics braking sequence. In some instances, the waveform signal generator 112 includes a waveform signal library including sets of pre-generated waveform signals. The drive signal 102 includes a haptics actuator waveform (e.g., generated by the waveform signal generator 112) to cause the haptics actuator 104 to vibrate in response to the waveform characteristics. The controller 108 also includes an adaptive model 114. The adaptive model 114 may output a feedback signal 124 that modifies the haptics actuator waveform. To this end, the adaptive model 114 receives inputs from current and voltage measurements 118, 120 of the drive signal 102. The current and voltage measurements 118, 120 are received continuously, periodically, or during specific events (e.g., at startup, factory calibration, or during system idle) and provide information about changes in haptics environment.

More particularly, the output from the adaptive model 114 is provided to an algorithm 122 of the controller 108. The controller 108 executes the algorithm 122 to generate the feedback signal 124. The feedback signal 124 is provided as an input to the waveform signal generator 112. The feedback signal 124 of some examples is generated according to a feedback signal protocol 126.

The adaptive model 114 may include a statistical or machine learning model that can adjust its behavior and parameters in response to new current and voltage measurement data. The adaptive model 114 improves and learns over time without the need for retraining or manual intervention. The adaptive model 114 can update predictions or tweak internal parameters in response to changes in the haptics environment or measurements.

By training the adaptive model 114 using real time current and voltage measurements 118, 120, and letting the adaptive model control the feedback signal 124, the controller 108 is able to accurately tune the drive signal 102 more quickly than would be possible for the controller 108 to react directly to the current and voltage measurements 118, 120. This is because, in part, of the latency in receiving the current and voltage measurements 118, 120 at the controller 108. The feedback signal 124 is generated without such latency by virtue of the adaptive model 114 being included within the controller 108. As such, implementations present a hybrid approach that allows instantaneous, modeled updates to the drive signal 102, while the adaptive model 114 is updated in a slow manner responsive to real time voltage and current measurements 118, 120 by exploiting the fact that the changes in haptics environment is inherently slow in nature.

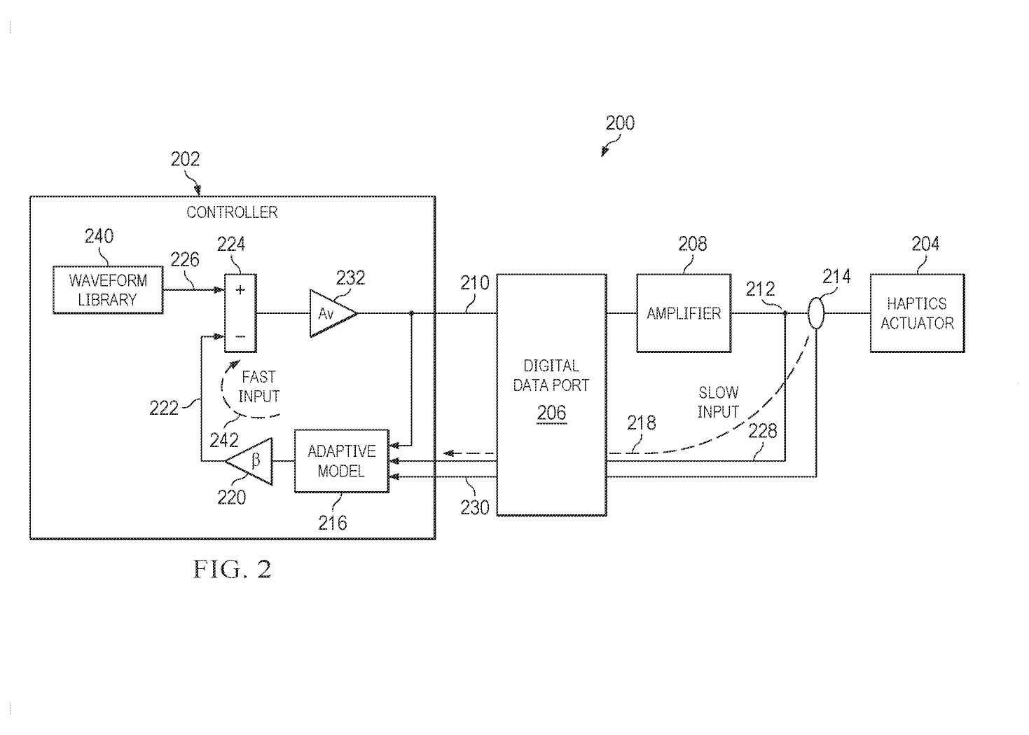

FIG. 2 is a block diagram of an example of a system 200 including a controller 202 to cause a haptics actuator 204 to vibrate in a manner responsive to an output from an adaptive model 216. The controller 202 communicates with the haptics actuator 204 in FIG. 2 via a digital data port 206 and an amplifier 208. The digital data port 206 includes a physical connection point on a device that allows for the transmission of digital data. The controller 202 may be similar to the controller 108 of FIG. 1. Likewise, the haptics actuator 204 may be similar to the haptics actuator 104 of FIG. 1, and the amplifier 208 may be similar to the amplifier 110 of FIG. 1. As with other diagrams included herein, additional functional blocks may be included, and included blocks may be omitted or rearranged, per the specific implementations contemplated within this description.

Turning more particularly to the drawing, the controller 202 has an output coupled to an input of the digital data port 206. The digital data port 206 includes a physical interface through which the drive signal 210 is transferred. The drive signal, which is output of the controller 202, includes a haptics actuator waveform to drive the haptics actuator 204. An output of the digital data port 206 is coupled to an input of the amplifier 208. An output of the amplifier 208 is coupled to an input of the haptics actuator 204. As such, the drive signal 210 is communicated from the controller 202 to the haptics actuator 204.

A voltage measurement 228 of the drive signal 210 is detected at node 212. A current measurement 230 of the haptics actuator 204 in response to the drive signal 210 is sensed at node 214. Though not shown in FIG. 2, a voltage sensor may be present at node 212, and a current sensor may be present at node 214. The voltage measurement 228 and the current measurement 230 are passed via the digital data port 206 to the controller 202.

More particularly, the voltage measurement 228 and the current measurement 230 are communicated to inputs of the adaptive model 216. Another input to the adaptive model 216 includes the drive signal 210, as output from the gain block 232. The gain block 232 amplifies the level (e.g., increases the signal gain) of the drive signal 210. The adaptive model 216 modifies the drive signal 210 to cause vibrations of the haptics actuator 204 to cease abruptly and crisply (e.g., without a gradual tapering).

As depicted in FIG. 2, a feedback signal 222 is output from the adaptive model 216 and is received at an input of a gain block 220. The gain block 220 increases the level of the feedback signal 222, which is communicated as an input to a waveform modification circuit 224. More specifically, the output from the adaptive model 216 of some examples can be an estimate of the Back-EMF signal of the haptics actuator 204 predicted by the adaptive model 216 from the drive signal input 210.

Another input to the waveform modification circuit 224 comprises an output from a waveform library 240. As described herein, the waveform library 240 outputs a haptics actuator waveform 226 generated to cause the haptics actuator 204 to vibrate in a manner responsive to its waveform characteristics. The waveform modification circuit 224 modifies the haptics actuator waveform 226 responsive to the feedback signal 222. More specifically, the waveform modification circuit 224 of some examples generates an output signal which is the difference between the haptics actuator waveform 226 and feedback signal 222. As described herein, the adaptive model 216 is updated based on voltage measurement 228 and current measurement 230. The adaptive model 216 generates an output signal based on the drive signal 210 which is amplified using the gain block 220 to generate the feedback signal 222. The waveform modification circuit 224 outputs a signal which is amplified by the gain block 232 and communicated as the drive signal 210.

Because the feedback signal 222 is generated within the controller 202 based on the drive signal 210, the output of the adaptive model 216 is characterized in FIG. 2 as being a fast input loop 242. Accordingly, the feedback signal 222 is used to modify the haptics actuator waveform 226 more quickly than the voltage measurement 228 and the current measurement 230 are provided to the controller 202 (e.g., to update the adaptive model 216). As such, the updating of the adaptive model 216 using the voltage measurement 228 and the current measurement 230 is labeled in FIG. 2 as a slow input loop 218.

Put another way, the adaptive model 216 is able to provide the adaptive output (e.g., via feedback signal 222) quicker than the voltage and current measurements 228, 230 can be received at the controller 202. This is because, in part, of the latency in receiving the voltage and current measurements 228, 230 at the controller 202. The feedback signal 222 is generated without such latency by virtue of the adaptive model 216 being positioned within the controller 202. As such, the vibrations at the haptics actuator 204 are effectively halted responsive to the drive signal 210. Moreover, including the adaptive model 216 within the controller allows that adaptive model 216 to leverage the existing processing resources that are already present in the controller 202.

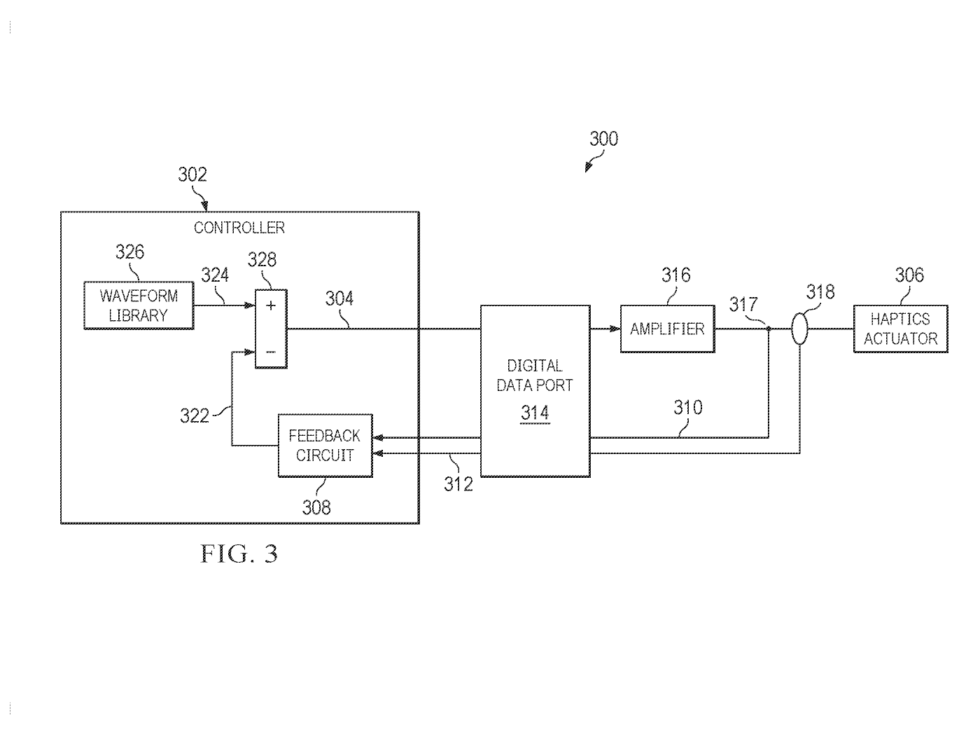

FIG. 3 is a block diagram of an example of another system 300 including a controller 302 that generates a drive signal 304 to control the vibrations of a haptics actuator 306. The controller 302 includes a feedback circuit 308 that updates the drive signal 304 responsive to detected voltage and current measurements 310, 312. The controller 302 transmits the drive signal 304 to the haptics actuator 306 in FIG. 3 via a digital data port 314 and an amplifier 316. The controller 302 may be similar to the controller 108 of FIG. 1, for instance, and the haptics actuator 306 may be similar to the haptics actuator 104 of FIG. 1. The amplifier 316 may be similar to the amplifier 110 of FIG. 1.

The controller 302 has an output coupled to an input of the digital data port 314. An output of the digital data port 314 is coupled to an input of the amplifier 316. An output of the amplifier 316 is coupled to an input of the haptics actuator 306. As such, the drive signal 304 is communicated from the controller 302 to the haptics actuator 306. A voltage sensor may be present at 317, and a current sensor may be present at 318. The voltage measurement 310 and the current measurement 312 are passed via the digital data port 314 to the controller 302.

More particularly, the voltage measurement 310 and the current measurement 312 are communicated to inputs of the feedback circuit 308. The feedback circuit 308 modifies the drive signal 304 to cause vibrations of the haptics actuator 306 to halt without a gradual tapering. More particularly, the feedback circuit 308 generates a feedback signal 322 that modifies a haptics waveform signal 324 output from the waveform library 326. As depicted in FIG. 3, the feedback signal 322 and the haptics waveform signal 324 are combined at a waveform modification circuit 328. The waveform modification circuit 328 outputs the drive signal 304 to the digital data port 314.

As the feedback signal 322 is generated within the controller 302, the processors of the controller are able to modify the drive signal 304 faster than the voltage measurement 310 and the current measurement 312 could otherwise be received and processed at the controller 302. As such, the vibrations at the haptics actuator 306 are effectively halted responsive to the drive signal 304.

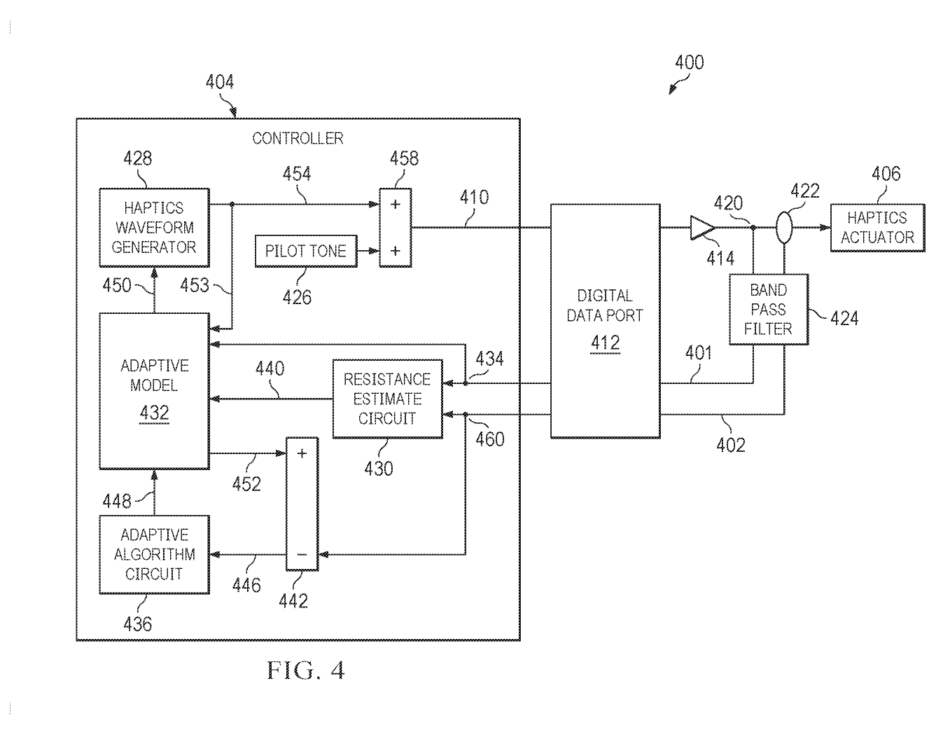

FIG. 4 is a block diagram of an example of another system 400 that includes an adaptive model 432 trained on voltage and current measurements 401, 402. The adaptive model 432 is included within a controller 404 that causes a haptics actuator 406 to vibrate responsive to waveform characteristics of a drive signal 410. The controller 404 communicates with the drive signal 410 to the haptics actuator 406 in FIG. 4 via a digital data port 412 and an amplifier 414. The controller 404 may be similar to the controller 108 of FIG. 1. Likewise, the haptics actuator 406 may be similar to the haptics actuator 104 of FIG. 1, and the amplifier 414 may be similar to the amplifier 110 of FIG. 1.

As shown in FIG. 4, the controller 404 has an output coupled to an input of the digital data port 412. The digital data port 412 comprises a physical interface through which the drive signal 410 is transferred. An output of the digital data port 412 is coupled to an input of the amplifier 414. An output of the amplifier 414 is coupled to an input of the haptics actuator 406. As such, the drive signal 410 is communicated from the controller 404 to the haptics actuator 406.

The voltage measurement 401 of the drive signal 410 is detected at node 420. The current measurement 402 of the haptics actuator 406 in response to the drive signal 410 is sensed at node 422. Though not shown in FIG. 4, a voltage sensor may be present at node 420, and a current sensor may be present at node 422. The voltage measurement 401 and the current measurement 402 are passed via the digital data port 412 to the controller 404.

In the implementation of FIG. 4, the voltage and current measurements 401, 402 are coupled to inputs of a band pass filter 424. The band pass filter 424 passes one or more frequencies within a certain frequency range while rejecting frequencies outside of the predetermined range. In the implementation of FIG. 4, the band pass filter 424 passes one or more frequencies corresponding to that of a pilot tone 426. The pilot tone 426 may include a low frequency output signal that is added with the higher signal frequency of the drive signal 410. The pilot tone 426 in some examples is generated by a digital oscillator.

The pilot tone 426 may be added to the haptics waveform signal 454 at a signal adder circuit 458. As such, the drive signal 410 of some implementations includes both the high and low frequencies that are communicated to the amplifier 414. For instance, the frequency of the pilot tone 426 may be tuned to cause the haptics actuator 406 to vibrate at around 16 Hz, whereas the larger frequency of the haptics waveform signal 454 causes the haptics actuator 406 to vibrate at around 200 Hz. In other examples, the pilot tone 426 may be transmitted in place of the haptics waveform signal 454 (e.g., during a dedicated calibration operation). In either case, the relatively low signal level of the pilot tone preserves power at the amplifier 414 that is instead used to vibrate the actuator.

As an additional benefit, the relatively lower frequency of the pilot tone 426 allows the haptics actuator 406 to function as a nearly perfect resistor. Accordingly, the haptics actuator 406 (e.g., when vibrating at the low frequency) exhibits nearly only resistance and has no additional properties, such as inductance or capacitance. The absence of inductance and capacitance enables a resistance estimate circuit 430 to estimate the resistance of the haptics actuator 406. The resistance estimate is used by the adaptive model 432 to adapt to changes in haptics environment.

The voltage and current measurements 401, 402 are communicated to inputs of a resistance estimate circuit 430 via the band pass filter 424. Filtering the frequency of the pilot tone 426 at the band pass filter 424 enables the resistance estimate circuit 430 to divide the voltage measurement 401 by the current measurement 402 to accurately estimate the resistance. The estimated resistance is output to an input of the adaptive model 432 via signal 440.

Another input to the adaptive model 432 includes the voltage measurement 401 at node 434. The adaptive model 432 of some implementations uses the voltage measurement 401 and the estimated resistance 440 to predict a current. In some implementations, the inputs are used as variables in a second order algorithm. Other implementations use machine learning over time to predict the current.

The predicted current 452 is output from the adaptive model 432 to an input of a comparator circuit 442. The comparator circuit 442 of some examples compares the predicted current 452 to the current measurement 402 at node 460. In other examples, the current measurement 402 is used to predict a voltage (e.g., at the adaptive model 432), which is compared with the voltage measurement 402. In FIG. 4, the result of the comparison is output as a comparison signal 446. The comparison signal 446 is input to an adaptive algorithm circuit 436. The adaptive algorithm circuit 436 of some examples determines if a difference between the predicted current 452 and the current measurement 402 exceeds a preset threshold. In other examples, the adaptive algorithm circuit 436 determines if a difference between the predicted voltage (e.g., output from the adaptive model 432) and the voltage measurement 401 exceeds a preset threshold. In either case, if the difference is a predetermined level of significance, the adaptive algorithm circuit 436 transmits an update signal 448 to an input of the adaptive model 432. The update signal 448 includes adjustment data used to update the parameters of the adaptive model 432.

As illustrated in FIG. 4, a feedback signal 450 is output from the adaptive model 432 and received at an input of the haptics waveform generator 428. More specifically, the feedback signal 450 in some examples can be an estimate of the back-EMF signal of the haptics actuator predicted by the adaptive model 432 from the haptics actuator waveform 454. The adaptive model 432 increases the gain of the feedback signal 450, which is communicated as an input to the haptics waveform generator 428. The gain of the feedback signal may be similar to the gain block 220 of FIG. 2. The haptics waveform generator 428 of some examples adjusts the haptics actuator waveform 454 in proportion to the difference between the feedback signal 450 and the waveform generated within the haptics waveform generator 428 to efficiently halt vibrations at the haptics actuator 406.

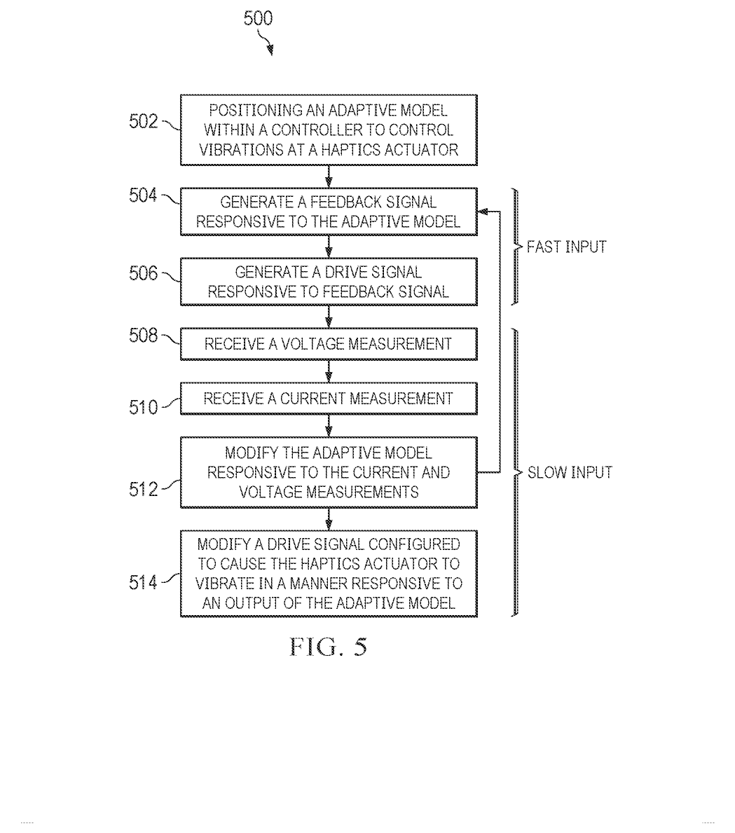

FIG. 5 is a flowchart of an example of a method 500 of controlling vibrations at a haptics actuator responsive to a haptics waveform signal that is modified by an adaptive model. The illustrative method 500 may be performed by any of the preceding systems of FIGS. 1-4. As with other diagrams included herein, additional blocks may be included, and included blocks may be omitted or rearranged per the specific implementations contemplated within this description.

Turning more particularly to the flowchart, the method 500 includes positioning at block 502 an adaptive model within a controller to control the vibrations of a haptics actuator. For instance, the controller 202 of FIG. 2 includes the adaptive model 216. Inclusion of the adaptive model within the controller allows that adaptive model to leverage the existing processing resources that are already present in the controller. As described herein, the positioning of the adaptive model further enables quicker adaptations to the drive signal.

At block 504, the method 500 includes generating a feedback signal that is responsive to the adaptive model. For example, the adaptive model 216 of FIG. 2 generates a feedback signal 222. The feedback signal 222 is used to modify the drive signal 210 that causes the haptics actuator 204 to vibrate, as shown at block 506 of the flowchart. Because the feedback signal is generated within the controller, the blocks 504 and 506 are characterized in FIG. 5 as being a fast input loop. Accordingly, the feedback signal is used to modify the haptics actuator waveform more quickly than the voltage measurement and the current measurement received at blocks 508 and 510 can be provided to the controller (e.g., to update the adaptive model).

As such, modifying the adaptive model at block 512 using the voltage measurement and the current measurement is labeled in FIG. 5 as being part of a slow input loop. FIG. 2 illustrates the voltage measurement 228 and the current measurement 230 being received at the adaptive model 216.

At 514, the method 500 includes modifying the drive signal that causes the haptics actuator to vibrate in a manner that is responsive to an output of the adaptive model. For instance, the feedback signal 222 of FIG. 2 is used to modify the drive signal 210, which controls the operation of the haptics actuator 204.

By using a feedback signal within the controller to modify the drive signal, the method 500 more quickly halts vibrations at the haptic actuator than would be possible using actual voltage and current measurements. The modeled feedback signal does not suffer latency that would otherwise be incurred in receiving and processing the current and voltage measurements at the controller.

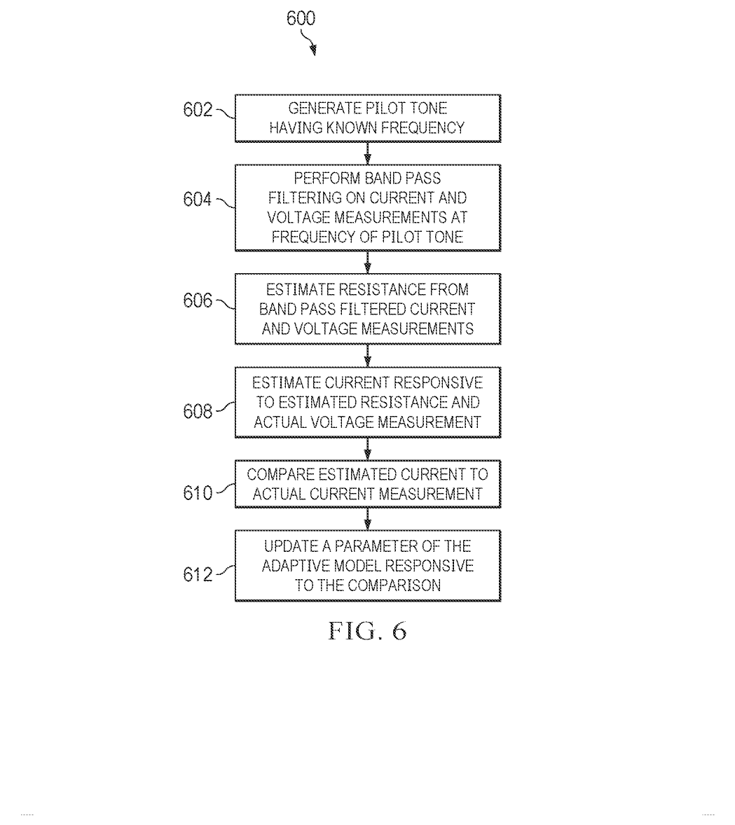

FIG. 6 is a flowchart of an example of a method 600 of modifying an adaptive model to adjust a drive signal to control the vibrations of a haptics actuator. The illustrative method 600 may be performed by any of the preceding systems of FIGS. 1-4. For explanatory purposes, the method 600 is described in the context of the system 400 of FIG. 4.

Turning more particularly to the flowchart, the method 600 includes generating at block 602 a pilot tone having a predetermined frequency. For example, the pilot tone 426 of FIG. 4 is used to generate a portion of the drive signal 410.

At block 604, the method 600 includes band pass filtering the current and voltage measurements at the frequency of the pilot tone. For instance, the band pass filter 424 of FIG. 4 is used to perform band pass filtering on the current measurement 402 and the voltage measurement 401.

At block 606, the method 600 includes estimating the resistance from the band pass filtered current and voltage measurements. For example, the voltage measurement 401 and the current measurement 402 of FIG. 4 are provided as inputs to the resistance estimate circuit 430.

The current may be estimated at block 608 in a manner that is responsive to the estimated resistance (e.g., determined at block 606) and the actual voltage measurement. For instance, an estimated current 452 is output from the adaptive model 432 of FIG. 4. The adaptive model 432 receives the estimated resistance 440 from the resistance estimate circuit 430. The adaptive model also receives the haptics waveform signal 454 via a connection 453, as output from the waveform generator 428.

At block 610, the method 600 includes comparing the estimated current (e.g., determined at block 608) to the actual current measurement. For example, the estimated current 452 of FIG. 4 is compared to the current measurement 402.

A parameter of the adaptive model is updated at block 612 in response to the comparison of block 610. For instance, the adaptive algorithm circuit 436 of FIG. 4 selectively outputs an update signal 448 to update a parameter or a set of parameters of the adaptive model 432.

In this manner, the illustrative method 600 of FIG. 6 may train the adaptive model (e.g., using actual current and voltage measurements) to accurately tune the drive signal. The drive signal is modified in a manner that avoids potential latency associated with receiving the current and voltage measurements at the controller. The method 600 generates the feedback signal without such latency by virtue of the adaptive model being included within the controller.

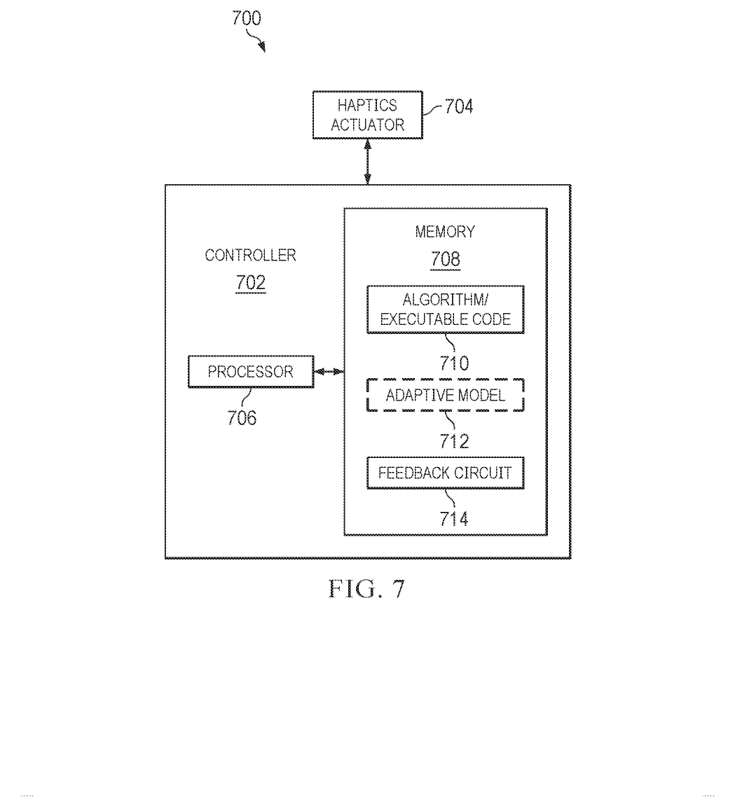

FIG. 7 is a block diagram of an example of a system 700 that includes a controller 702 that is coupled to a haptics actuator 704. The controller 702 includes a processor 706 that is in communication with a memory 708. The memory 708 includes an algorithm, or executable code 710, that is executable by the processor to control operation of the haptics actuator 704. An adaptive model 712 is shown as included within the controller 702. The adaptive model 712 is shown in dashed lines because another implementation may generate the drive signal using a feedback circuit 714 without a model. The feedback circuit 714 may be similar to the feedback circuit 308 of FIG. 3, and the adaptive model 712 may be similar to the adaptive model 216 of FIG. 2.

The controller 702 refers to any type of device that has some amount of hardware processing capability and/or hardware storage/memory capability (e.g., memory 708). The processor 706 refers to one or more hardware processors (e.g., hardware processing units/cores) that can execute data in the form of computer-readable instructions (e.g., executable code 710). When executed, the executable code 710 can cause the processor 706 to provide functionality.

Computer-readable instructions and/or data can be stored on storage, such as storage/memory and or the datastore. The term “system” as used herein can refer to a single device, multiple devices, etc. Storage resources or other memory can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term "computer-readable medium" can include signals. In contrast, the term "computer-readable storage medium" excludes signals.

Computer-readable storage media includes "computer-readable storage devices." Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can coordinate with shared resources, such as memory, storage, etc., and/or one or more dedicated resources, such as hardware blocks perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code described herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is configured to perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/- 10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

What is claimed is:

1. An apparatus, comprising:
a memory storing an adaptive model and an algorithm executable to generate a drive signal of a haptic actuator; and
a processor configured to access the memory and execute the algorithm to:
modify the adaptive model responsive to one or both of a voltage measurement of the drive signal and a current measurement of the haptics actuator responsive to the drive signal; and
generate a feedback signal responsive to the adaptive model, wherein the drive signal is responsive to the feedback signal.

2. The apparatus of claim 1, further including an amplifier having an input coupled to an output of the processor and having an output coupled to an input of the haptics actuator, wherein the amplifier is configured to provide the drive signal to the haptics actuator.

3. The apparatus of claim 1, wherein the processor is further configured to estimate the current measurement responsive to the adaptive model.

4. The apparatus of claim 3, wherein the processor is further configured to compare the estimate of the current measurement and the current measurement.

5. The apparatus of claim 4, wherein the processor is configured to update a parameter of the adaptive model responsive to the comparison.

6. The apparatus of claim 1, wherein inputs to the adaptive model include at least two of: a haptics waveform signal, the drive signal, the voltage measurement, an estimated resistance of the drive signal, and a modification to a parameter of the adaptive model.

7. The apparatus of claim 1, further including a band pass filter coupled to an input of the haptics actuator and to an input of the processor, wherein the processor estimates a resistance responsive to a bandpass-filtered measurement of one or both of the voltage measurement and the current measurement.

8. The apparatus of claim 7, wherein the processor generates a pilot tone having a frequency tuned to be passed through the band pass filter.

9. The apparatus of claim 1, further including a voltage sensor coupled to an input of the haptics actuator to measure the voltage measurement, wherein an output of the voltage sensor is coupled to an input of the processor.

10. The apparatus of claim 1, further including a current sensor coupled to an input of the haptics actuator and configured to sense the current measurement, wherein an output of the current sensor is coupled to an input of the processor.

11. The apparatus of claim 1, wherein the processor is further configured to continuously modify the adaptive model responsive to the voltage and current measurements.

12. The apparatus of claim 1, wherein the processor is further configured to modify the adaptive model during one or more of: factory calibration, system idle, and system startup.

13. The apparatus of claim 1, wherein the adaptive model includes a machine learning algorithm.

14. A system, comprising:
an amplifier to amplify a drive signal;
a haptics actuator having an input coupled to an output of the amplifier, wherein the haptics actuator vibrates responsive to the drive signal;
a voltage sensor coupled to the input of the haptics actuator to measure a voltage measurement of the drive signal;
a current sensor coupled to the input of the haptics actuator to measure a current measurement of the haptics actuator in response to the drive signal; and
a controller coupled to an output of the current sensor and an output of the voltage sensor, wherein the controller:
receives the voltage and current measurements; and
generates a feedback signal responsive to the voltage and current measurements; and
modifies the drive signal responsive to the feedback signal.

15. The system of claim 14, wherein the controller estimates a resistance responsive to the current measurement and the voltage measurement, and wherein the controller further generates the feedback signal responsive to the estimated resistance.

16. The system of claim 14, wherein the controller generates the feedback signal responsive to at least one protocol selected from a group consisting of: a factory calibration protocol, a system idle protocol, a continuous update protocol, a periodic update protocol, and a system startup protocol.

17. The system of claim 14, wherein the controller further generates a current estimate and compares the current estimate to the current measurement.

18. A computer program product for generating a drive signal configured to cause a haptics actuator to vibrate, the computer program product including a computer-readable storage medium having computer-readable program code embodied therewith, the computer-readable program code to be executed by a controller to:
modify an adaptive model of a haptics actuator responsive to a voltage measurement of a drive signal and a current measurement of the haptics actuator in response to the drive signal;
predict a back electromagnetic force of the haptics actuator responsive to the adaptive model; and
generate a feedback signal responsive to the prediction.

19. The computer program product of claim 18, wherein the predicted back electromagnetic force includes an estimated current of the haptics actuator in response to the drive signal, and wherein the computer-readable program code is further executable by the controller to perform a comparison of the estimated current to the current measurement, and to update a parameter or a set of parameters of the adaptive model responsive to the comparison.

20. The computer program product of claim 18, wherein the predicted back electromagnetic force includes an estimated resistance of the drive signal.
